(19) United States
(12) Patent Application Publication
(10) Pub. No.: US 2009/0220105 A1
(43) Pub. Date: Sep. 3, 2009

(54) METHOD FOR COMPENSATING FOR CHANGES IN REPRODUCED AUDIO SIGNALS AND A CORRESPONDING DEVICE

(76) Inventor: Harry Bachmann, Stafia (CH)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/913,342

(22) PCT Filed: Apr. 12, 2006
(86) PCT No.: PCT/CH06/00205

§ 371 Date: Jun. 18, 2008

(30) Foreign Application Priority Data
May 1, 2005 (CH) 765/05

(51) Int. Cl. H04B 15/00

(52) U.S. Cl. 381/94.1

(57) ABSTRACT

An apparatus and method for compensating for changes, which result on an original signal (17) due to a transmission along a signal path (2, 3, 4, 7) from a source (1) to a receiving listener (5) involve compensating the changes in the original signal occurring in the signal path (2, 3, 4, 7) by minimizing differences between the original signal (17) and a reproduced signal, which is perceived by the receiving listener (5). This makes it possible for the receiving listener (5) to perceive the originally recorded original signal (17).

### RELATED APPLICATION

This is a U.S. national phase application under 35 U.S.C. §371 of International Application No. PCT/CH2006/000205 filed Apr. 12, 2006 which claims priority of Switzerland Application No. 765/05 filed May 1, 2005.

### TECHNICAL FIELD

The invention relates to a method for compensating changes in reproduced signals that arise because of transmission along a signal path from a source to a receiver, and a corresponding apparatus for compensating changes.

### BACKGROUND AND SUMMARY

The reproduction of an audio signal is optimal when a listener can detect no differences between the original and its reproduction. This is ensured only in very rare cases, because an original audio signal is distorted in a great many different ways from the source to a listener's ear. The causes of these distortions are varied in nature. Thus for example the quality of the playback devices employed plays a role, as does the response of the room in which the audio signal is to be reproduced. A sound wave in a room is affected by reflections and absorptions. The signal is also subjected to a change in a signal conversion, for example from analog to digital form and/or from digital to analog form. What is more, the signal experiences a change when the level is altered in order to ensure the compatibility of various devices throughout the signal chain. Further, every cable and every plug connection has an effect on the signal to be reproduced. The conversion of the electrical signal to a sound wave, which takes place in a loudspeaker, also changes the signal, the loudspeaker possibly being of any design. Moreover, a headphone also changes the signal to be reproduced; for example, both the shell of the headphone and the transducer used to generate sound affect the signal. The cable of a headphone additionally changes the signal as a consequence of unequal impedances and other linear and nonlinear properties of the materials used and the fashioning of the cable and plugs. The same holds when the signal is transmitted wirelessly. In summary, it can be stated that every element in the signal transmission chain from source to listener affects the signal to be reproduced. The consequence is that between an original signal and its reproduction there are differences that are perceived to varying degrees by a listener and are generally assessed by the listener as disturbing.

It is therefore an object of the invention to identify a method for compensating changes in reproduced signals, the method not exhibiting the above stated disadvantages.

This object is achieved with the method of the invention for compensating changes to an original signal that arise because of transmission along a signal path from a source to a receiver, the method comprising compensating the changes in the original signal occurring in the signal path by minimizing differences between the original signal and a reproduced signal detected by the receiver, using an adaptive algorithm. Advantageous developments and an apparatus are described below.

The method according to the invention serves in particular to minimize signal distortions occurring in the reproduction of audio signals. This minimization or compensation advantageously takes place in continuous fashion, that is, in real time.

In one variant embodiment, the method now consists in that the original signal to be reproduced is employed for minimizing the error. Further, the original signal is compared with the reproduced signal and optimized by a filter or a transfer function controlled by the adaptive algorithm, preferably in the frequency domain. In a variant embodiment the filter operates in the time domain while the calculations of the algorithm are performed in the frequency domain. Further, the properties of the room in which the signal is to be reproduced and further possible additional effects, throughout the signal path, on the signal to be reproduced are taken into account.

In this way a method is created that is particularly suitable for the compensation of signal changes, but with the method according to the invention the impairment occurring in the reproduction of audio signals can also be reduced to a minimum.

The method of the invention is suitable for application in a room in which there are one or a plurality of listeners who hear the reproduction of an audio signal of any source either directly or via headphones.

### BRIEF DESCRIPTION OF DRAWINGS

In what follows, the invention is further explained on the basis of exemplary embodiments with reference to the Drawings, in which:

FIG. 1 depicts a possible situation in which the method according to the invention can be applied;

FIG. 2 depicts a further situation in which the method according to the invention can be applied;

FIG. 3 is a simplified block diagram on the basis of which the method according to the invention is illustrated;

FIG. 4 is a simplified block diagram of an application of the method according to the invention in a situation according to FIG. 1; and

FIG. 5 is a simplified block diagram of a further application of the method according to the invention in a situation according to FIG. 2.

### DETAILED DESCRIPTION

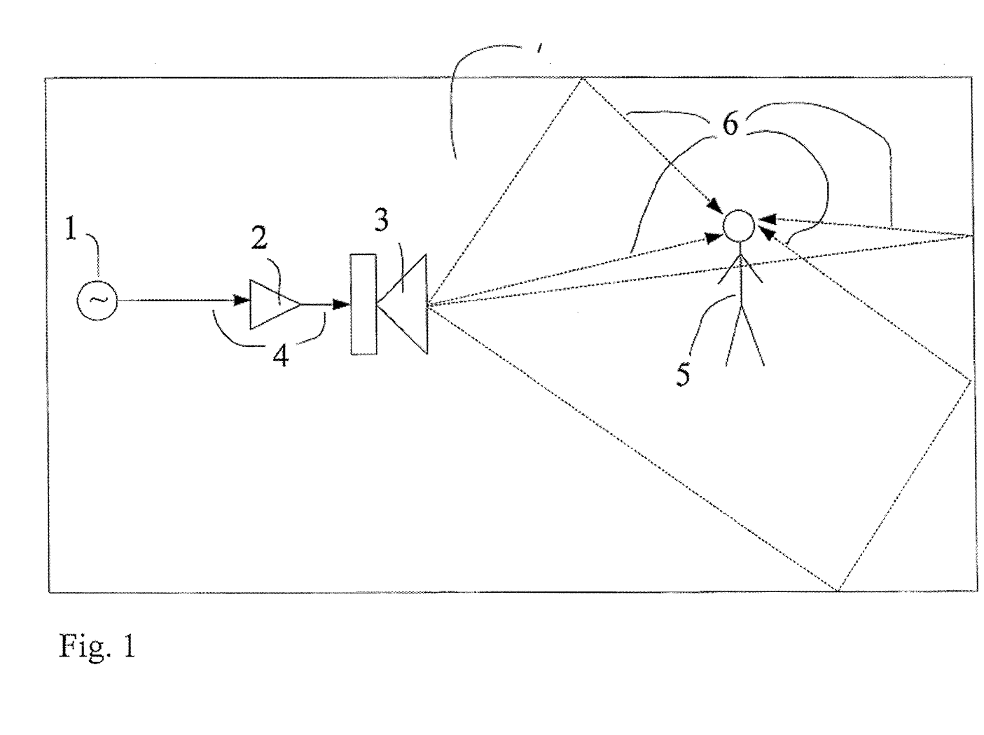

FIG. 1 depicts the various possible ways in which an audio signal to be reproduced can be affected in a known application in a room 7. The signal to be reproduced, from a source 1, is fed to an amplifier 2, this amplifier 2 also representing any other devices present for signal adaptation and signal conditioning, for example equalizers or delay devices. In this case for example a loudspeaker serves as audio transducer 3. A hearer 5 is located in room 7 and receives the reproduced signal, the signal emitted by audio transducer 3 moving along various signal routes 6 in room 7. The original signal present at the output of source 1 is affected by impedances of the connections present between source 1 and amplifier 2 and between amplifier 2 and the audio transducer respectively, by the electrical properties of amplifier 2 and by the acoustical and electrical properties of audio transducer 3. After the electrical signal has been converted into sound waves in audio transducer 3, the signal is additionally affected by reflections and absorptions at planar and curved surfaces in room 7.

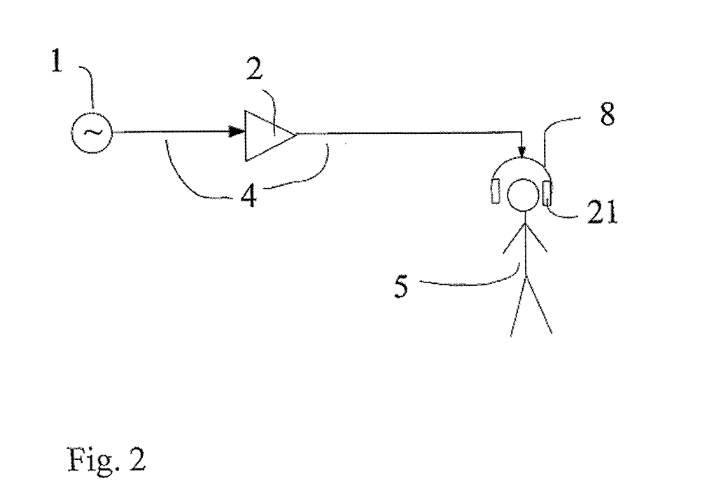

FIG. 2 depicts the reproduction of a signal when a headphone 8 is employed as audio transducer instead of the loudspeaker illustrated in FIG. 2. In distinction to FIG. 1, the effects of room 7 are absent or only slightly present when a headphone 8 is employed. Shells 21 of headphone 8 as well as their construction affect the signal to a degree that must not be underestimated. Headphone 8 contains transducers that additionally affect the signal and change it in such fashion that the reproduction of the signal perceived by hearer 5 deviates from the original signal present at source 1.

It is expressly pointed out that by no means all possible effects on the signal to be reproduced are illustrated and described in FIGS. 1 and 2. Further, only a few exemplary signal routes are indicated in FIGS. 1 and 2. Different configurations and dispositions having different effects on the signal to be reproduced are entirely possible. In addition to the signal routes 6 through the air medium identified by way of example, there may be additional signal routes (known as solid-borne sound) via solid materials such as for example walls or fastening materials.

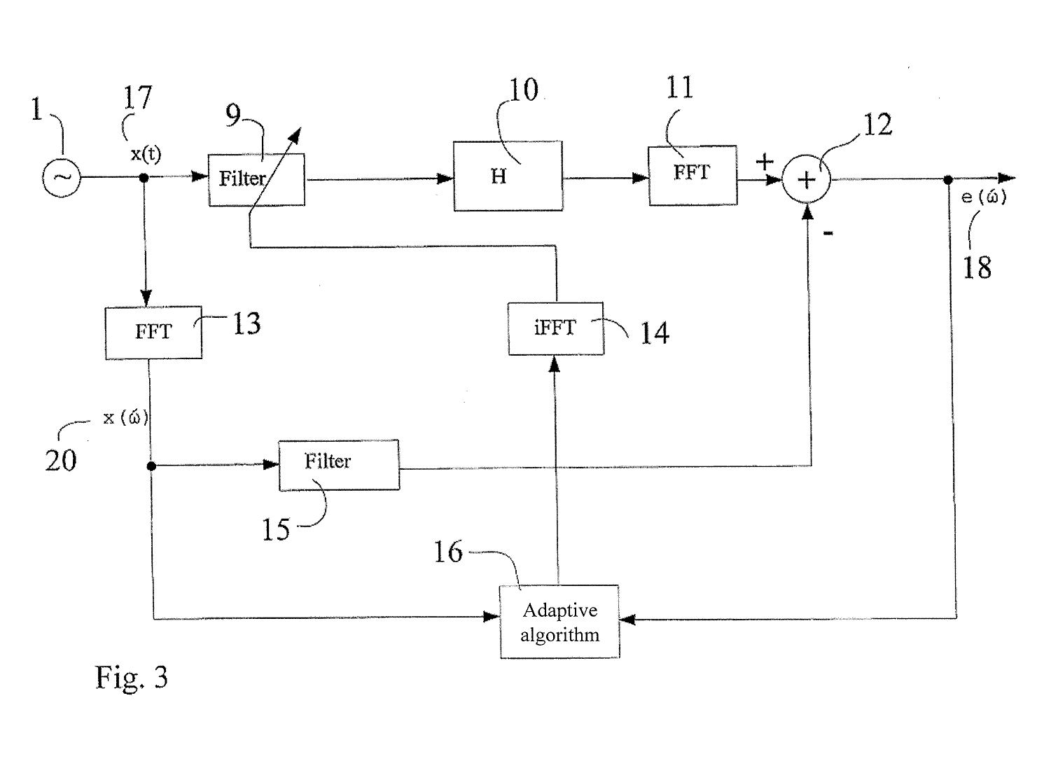

FIG. 3 gives a schematic block diagram on the basis of which the method according to the invention is explained. Source 1 generates an original signal x(t) 17 that is to be reproduced. The derivation of original signal 17 is not essential for this analysis. It can for example be a signal stored on a CD (compact disk) or a hard disk or, however, can be a signal picked up with a microphone. The properties of room 10 in which original signal x(t) 17 is to be reproduced are described by the transfer function H. Original signal x(t) 17 to be reproduced is supplied to a filter 9 and to transformation unit 13, in which for example a frequency transformation from the time domain to the frequency domain is carried out, preferably by a so-called FFT (fast Fourier transformation) or Hilbert transformation. An error signal e(\acute{ω}) 18 is the component of original signal x(t) 17 that is to be minimized in order to achieve a faithful reproduction of original signal x(t) 17, error signal e(\acute{ω}) 18 resulting from difference formation in an addition unit 12 having a value of zero in the optimal case. A further transformation unit 11 transforms the reproduced signal from the time domain to the frequency domain. Filter 9 is controlled by a processor 16 using an adaptive algorithm, and inverse transformation unit 14, in which for example an inverse FFT (or iFFT) is performed, transforms the filter parameters from the frequency domain to the time domain. Difference formation in addition unit 12 is effected by subtracting original signal 17, transformed to the frequency domain by transformation unit 13 and treated by a filter 15, from the reproduced signal, which is transformed to the frequency domain by further transformation unit 11. Filter 15 can be employed for generating a special effect by choosing an appropriate transfer function. Thus for example level matching can be performed in the case of the reproduced audio signal. If no special effects are to be generated in the case of the reproduced audio signal, filter 15 can be omitted so that unaltered transformed original signal x(\acute{ω}) is supplied to addition unit 12. In order that error signal e(\acute{ω}) can be determined with the aid of addition unit 12, the output signal of filter 15 is for example to be inverted, which takes place in filter 15 in the exemplary embodiment illustrated. In a processor 16, an adaptive algorithm compares original signal x(t) 17, transformed to the frequency domain by transformation unit 13, with error signal e(\acute{ω}) 18, which is already in the frequency domain, and adjusts filter 9 in such fashion that error signal e(\acute{ω}) 18 is minimized. Because original signal x(t) 17 is in the time domain, the filter parameters must be transformed from the frequency domain to the time domain by inverse transformation unit 14 before original signal x(t) 17 can be treated by filter 9.

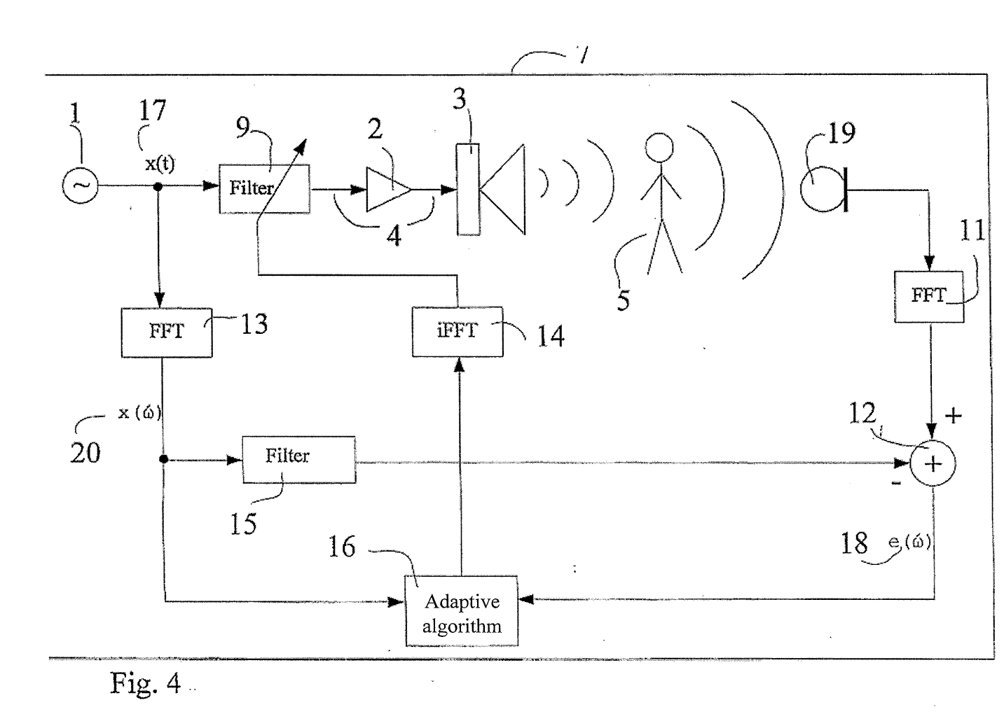

FIG. 4 depicts an application of the method according to the invention, the designations of process blocks of like function being provided with like reference characters. Original signal x(t) 17 stemming from source 1 is treated by filter 9, next amplified in amplifier 2 and then converted to sound by loudspeaker 3. Before this audio signal is received by hearer 5, the signal is subject to a number of changes brought about by the impedances of lines and connections 4, by amplifier 2, by loudspeaker 3 and by room 7. Sensor 19, in this case for example a microphone, receives the same signal as hearer 5 in the ideal case. The signal received by sensor 19 is transformed from the time domain to the frequency domain by transformation unit 11. Original signal x(t) 17 is transformed from the time domain to the frequency domain by transformation unit 13 and, as transformed original signal x(\acute{ω}), is available for subsequent treatment by filter 15. As was set forth in connection with the explanations to FIG. 3, filter 15 is suitable for the application of a special effect. As appropriate, also, only a signal inversion is implemented. By difference formation in addition unit 12, this filtered signal is then subtracted from the signal transformed by transformation unit 11. Processor 16, using an adaptive algorithm, for example an LMS (least mean square) algorithm, adjusts filter 9 in such fashion that error signal e(\acute{ω}) 18 resulting from difference formation is minimized. The smaller resulting error signal e(\acute{ω}) 18 is, the more similarity there is between original signal x(t) stemming from source 1 and the signal received by hearer 5. Because the adaptive algorithm applied in processor 16 operates with signals in the frequency domain, the parameters of filter 9 must be transformed from the frequency domain to the time domain by inverse transformation unit 14 before filter 9 can be adjusted with the use of these transformed parameters. It should be noted that sensor 19 also changes the received signal. The result can thus be improved by determining the properties of sensor 19 ahead of time and then taking account of them in the transformation to the frequency domain in transformation unit 11.

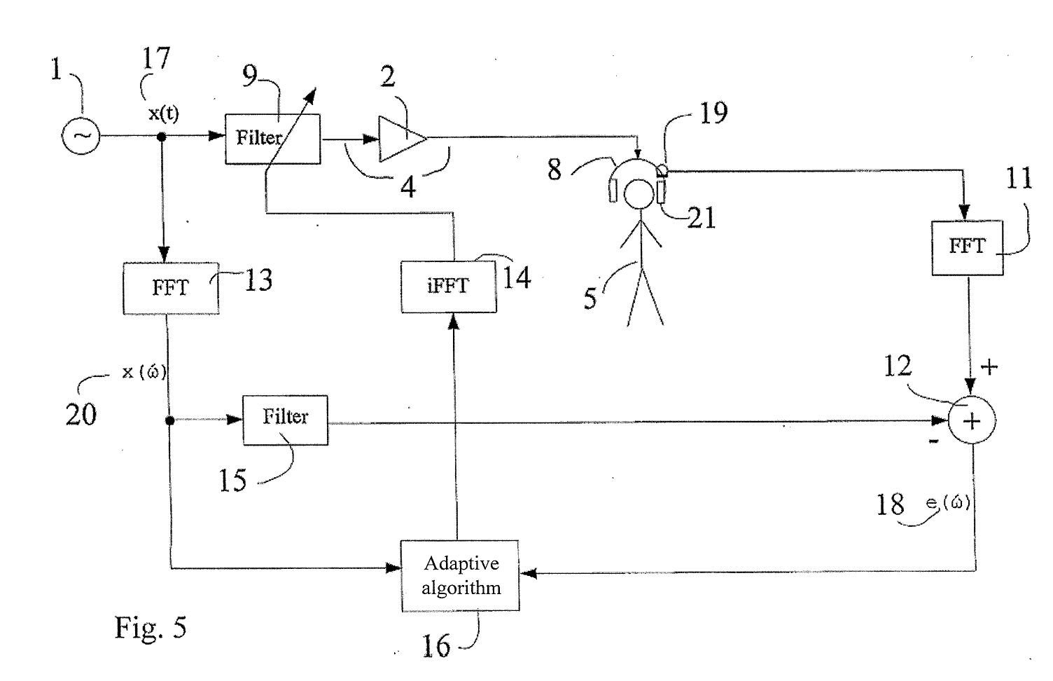

FIG. 5 depicts a further possible application of the method according to the invention, the process blocks once again being illustrated only schematically. Original signal x(t) 17 stemming from source 1 is treated by filter 9 and, after the level and impedance matching that takes place in amplifier 2, conveyed to headphone 8. Amplifier 2 and lines and connections 4 cause a change in original signal x(t), so that the signal received by hearer 5 no longer corresponds to original signal x(t). A microphone 19 is preferably used as the sensor integrated into headphone 8. The signal received by sensor 19 is transformed from the time domain to the frequency domain by transformation unit 11. Original signal x(t) 17 is transformed from the time domain to the frequency domain by transformation unit 13 and, as transformed original signal x(\acute{ω} ), is available for subsequent treatment by filter 15. This filtered signal is then subtracted, by difference formation in addition unit 12, from the signal transformed by transformation unit 11. Processor 16, in which adaptive algorithm 16 is applied, adjusts filter 9 in such fashion that error signal e(\acute{ω}) 18 resulting from difference formation in addition unit 12 is minimized. The smaller this resulting error signal e(\acute{ω}) 18 is, the more similarity there is between original signal x(t) stemming from source 1 and the signal received by hearer 5. Because the adaptive algorithm applied in processor 16 operates with signals in the frequency domain, the parameters of filter 9 must be transformed from the frequency domain to the time domain by inverse transformation unit 14 before filter 9 can be adjusted with the use of these transformed parameters. It should be noted that sensor 19 also changes the received signal. The result can thus be improved by determining the properties of sensor 19 ahead of time and then taking account of them in the transformation to the frequency domain in transformation unit 11.

A plurality of sensors can also be employed instead of a single sensor 19. In this case the adaptive algorithm applied in processor 16 uses an average formed from the individual signals in order to minimize error signal e(\acute{ω}) 18.

In a further application of the method of the invention, the use of a plurality of mutually independent systems—as previously described—is also possible. This can be desirable in the case of stereo signals because here distinct signals are emitted at distinct locations through various loudspeakers. Care should be taken in this case that the sensors employed do not affect one another, which can be ensured for example by appropriate placement of the sensors or by the employment of sensors having an appropriate directional response.

1. A method for compensating changes to an original signal (17) that arise because of transmission along a signal path (2, 3, 4, 7) from a source (1) to a receiver (5), comprising: compensating the changes in the original signal (17) occurring in the signal path (2, 3, 4, 7) by minimizing differences between the original signal (17) and a reproduced signal detected by the receiver (5), using an adaptive algorithm.

2. The method of claim 1, including acquiring the reproduced signal with a sensor (19) that is positioned as close as possible to the receiver (5).

3. The method of claim 1 wherein the compensating is effected with the aid of an adjustable filter (9) located in the signal path (2, 3, 4, 7).

4. The method of claim 1, including estimating the changes in the original signal (17) generated in the signal path (2, 3, 4, 7) and employing the estimated changes for compensating the changes caused in the signal path (2, 3, 4, 7).

5. The method of claim 1, including determining an estimated transmission segment (15) of the signal path (2, 3, 4, 7), determining an estimated reproduced signal on the basis of the estimated transmission segment (15), generating an error signal (18) from the estimated reproduced signal and the reproduced signal, optimizing the estimated transmission segment (15) on the basis of the error signal (18), and employing the estimated transmission segment (15) for compensating the changes.

6. The method of claim 1, including performing calculations to determine the compensation of the changes in the original signal (17) in the frequency domain.

7. The method of claim 6, including transforming the original signal (17) from the time domain to the frequency domain, and transforming the reproduced signal from the time domain to the frequency domain after it has been received by the sensor (19), and minimizing the error signal (18) in the frequency domain.

8. The method of claim 6, wherein the compensating is effected with the aid of an adjustable filter located in the signal path, and wherein calculations of the compensation are performed in the frequency domain and the adjustable filter (9) operates in the frequency domain.

9. An apparatus for compensating changes, the apparatus comprising:
a source (1) for specifying an original signal (17),
a signal path (2, 3, 4, 7) from the source (1) to a receiver (5), the changes to be compensated arising because of transmission of the original signal (17) from the source (1) to the receiver (5), wherein there are means (9) for compensating the changes occurring in the signal path (2, 3, 4, 7) by minimizing differences between the original signal (17) and a reproduced signal that is detected by the receiver (5).

10. The apparatus of claim 9 wherein there is a sensor (19) for acquiring the reproduced signal, the sensor (19) being positioned as close as possible to the receiver (5).

11. The apparatus of claim 9 wherein the means for compensating includes an adjustable filter in the signal path (2, 3, 4, 7) that is operatively connected to a transmission unit (16).

12. The apparatus of claim 9 wherein there are means (16) for estimating the changes in the original signal (17) generated in the signal path (2, 3, 4, 7), with the use of the estimated changes.

13. The apparatus of one claim 9, further comprising
means for determining an estimated transmission segment (15) of the signal path (2, 3, 4, 7),
means for determining an estimated reproduced signal on the basis of the estimated transmission segment (15),
means for generating an error signal (18) from the estimated reproduced signal and the reproduced signal,
means for optimizing the estimated transmission segment (15) on the basis of the error signal (18) and
means for compensating the estimated transmission segment (15).

14. The apparatus of claim 9 wherein there are means by which calculations to determine the compensation of the changes in the original signal (17) are performed in the frequency domain.

15. The apparatus of claim 14 wherein there are means for transforming the original signal (17) and the reproduced signal from the time domain to the frequency domain and means for minimizing the error signal (18) in the frequency domain.
